(19) United States
(12) Patent Application Publication
(10) Pub. No.: US 2021/0362407 A1
(43) Pub. Date: Nov. 25, 2021

(54) THREE-DIMENSIONAL (3D) PRINTING

(71) Applicant: Hewlett-Packard Development Company, L.P., Spring, TX (US)

(72) Inventors: Bradley B. Branham, Vancouver, WA (US); Carolin Fleischmann, San Diego, CA (US)

(73) Assignee: Hewlett-Packard Development Company, L.P., Spring, TX (US)

(21) Appl. No.: 17/045,522

(22) PCT Filed: Aug. 7, 2018
(86) PCT No.: PCT/US2018/045645

§ 371 Date: Oct. 6, 2020

(51) Int. Cl. B29C 64/165; B29C 64/357; B33Y 10/00; B33Y 40/00; B33Y 70/00

(52) U.S. Cl. CPC B29C 64/165; B29C 64/357; B33Y 70/00; B33Y 40/00; B33Y 10/00

(57) ABSTRACT

In an example of the present disclosure, a three-dimensional (3D) printing kit includes a build material composition and a fusing agent. The build material composition includes polymer particles and an organometallic compound thy-mixed with the polymer particles to prevent Coulombic agglomeration of the composition during pneumatic conveyance of the composition. The fusing agent is to be applied to at least a portion of the build material composition during 3D printing. The fusing agent includes an energy absorber to absorb electromagnetic radiation to coalesce the polymer particles in the at least the portion.

### BACKGROUND

3D printing may be an additive printing process used to make three-dimensional solid parts from a digital model. 3D printing is often used in rapid product prototyping, mold generation, mold master generation, and short run manufacturing. Some 3D printing techniques are considered additive processes because they involve the application of successive layers of material. This is unlike traditional machining processes, which often rely upon the removal of material to create the final part. 3D printing often requires curing or fusing of the building material, which for some materials may be accomplished using melting, or sintering, and for other materials may be accomplished using digital light projection technology.

### BRIEF DESCRIPTION OF THE DRAWINGS

Features of examples of the present disclosure will become apparent by reference to the following detailed description and drawings, in which like reference numerals correspond to similar, though perhaps not identical, components. For the sake of brevity, reference numerals or features having a previously described function may or may not be described in connection with other drawings in which they appear.

FIGS. 1A through 1D are semi-schematic, cross-sectional views showing formation of one layer of a 3D object using an example of the build material composition, 3D printing method and system disclosed herein;

FIG. 1E is a semi-schematic, cross-sectional view of an example of the 3D object that may be formed after performing FIGS. 1A through 1D several times;

FIG. 2 is an enlarged, semi-schematic, cut-away cross-sectional view of a portion of FIG. 1C;

FIG. 3 is a perspective view of the 3D object of FIG. 1E;

FIG. 4 is a simplified isometric view of an example of a 3D printing system that may be used in an example of the 3D printing method disclosed herein;

FIG. 5A is a schematic diagram depicting removing recyclable powdered build material from a 3D object and from a fabrication bed as disclosed herein;

FIG. 5B is a schematic diagram depicting pneumatic conveyance of build material composition in an example of a 3D print processing station;

FIG. 6 is a schematic diagram depicting an example of making a build material composition according to the present disclosure;

FIG. 7 is a block diagram depicting a 3D printing kit according to the present disclosure;

FIG. 8 is a flowchart depicting examples of a 3D printing method according to the present disclosure;

FIG. 9 is a flowchart depicting further examples of a 3D printing method according to the present disclosure;

FIG. 10 is an optical photomicrograph showing Build Material 1 before electrification using a DUST DEPUTY™ cyclone separator;

FIG. 11 is an optical photomicrograph showing Build Material 1 after electrification using the DUST DEPUTY™ cyclone separator; and

FIG. 12 is a photograph showing Build Material 1 before (left) and after (right) electrification using the DUST DEPUTY™ cyclone separator.

### DETAILED DESCRIPTION

Some three-dimensional (3D) printing methods use a fusing agent and exposure to radiation. In these processes, an entire layer of a build material (also referred to as build material particles) is exposed to the radiation, but a selected region (in some instances less than the entire layer) of the build material, i.e., the region exposed to the fusing agent, is fused and hardened to become a layer of a 3D part. It is to be understood that examples of the 3D printing kit 63 (see FIG. 7) and 3D printing method disclosed herein may be applied in 3D printing systems based on selective laser sintering (SLS) technology as well as the technology that utilizes the fusing agent and radiation.

As used herein, the terms “3D printed part,” “3D part,” or “part” may be a completed 3D printed part or a layer of a 3D printed part.

This present disclosure includes adding an organometallic compound as an anti-static agent (“anti-stat”) to resolve coulombic agglomeration due to contact electrification of pulverulent 3D build material during pneumatic conveyance. Coulombic agglomeration may lead to an improper flow of the pulverulent 3D build material, causing clogging or inhomogeneous densification. Recycled pulverulent 3D build material may be mixed with fresh pulverulent 3D build material in a 3D printing process. The genesis of recycled pulverulent 3D build material may expose the fresh pulverulent 3D build material powder to physical conditions (i.e., high temperature and humidity) that may diminish and degrade the anti-stat properties of currently available 3D printing powders. The present disclosure replaces the existing anti-stat additive in a 3D printing powder with an organometallic anti-stat compound that yields a build material composition 12 that has anti-stat characteristics with improved robustness to 3d printing process environments.

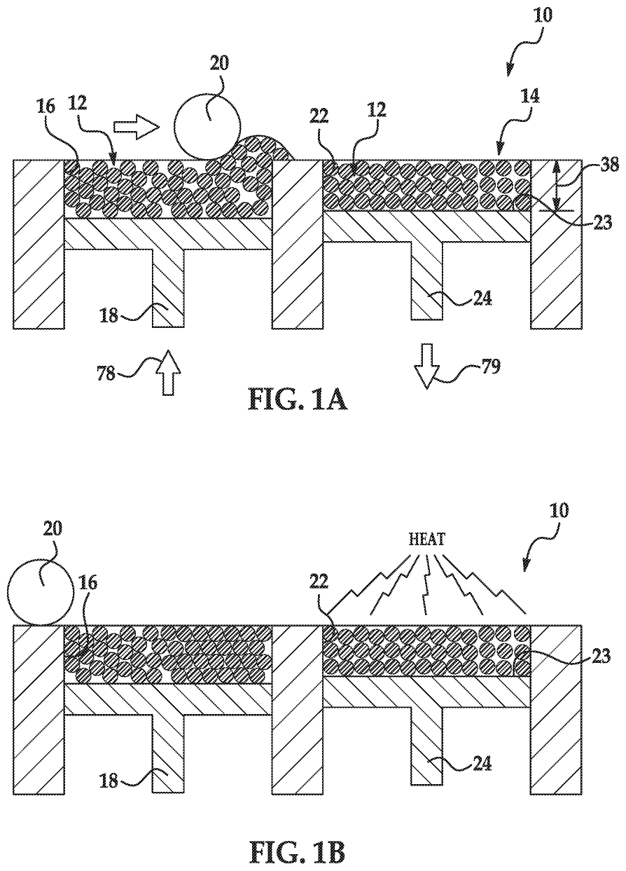

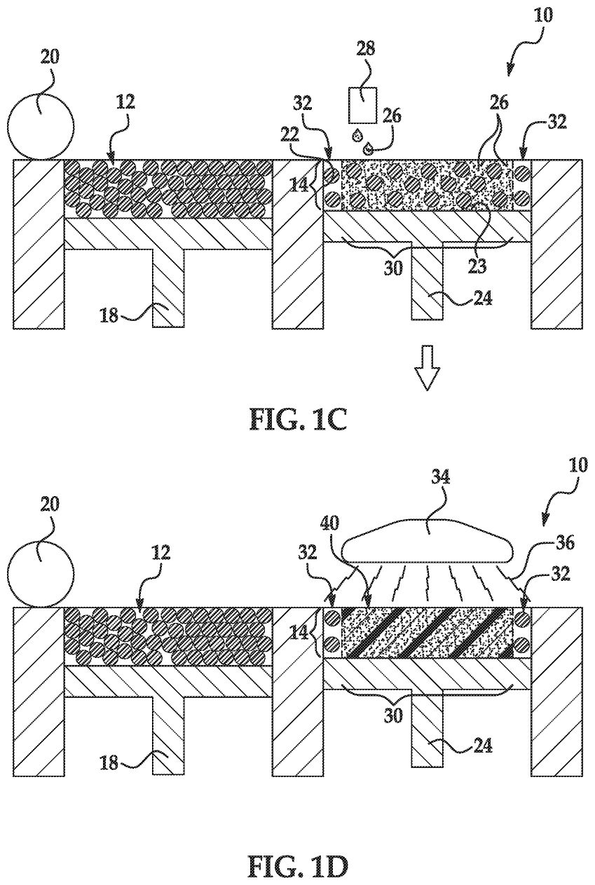

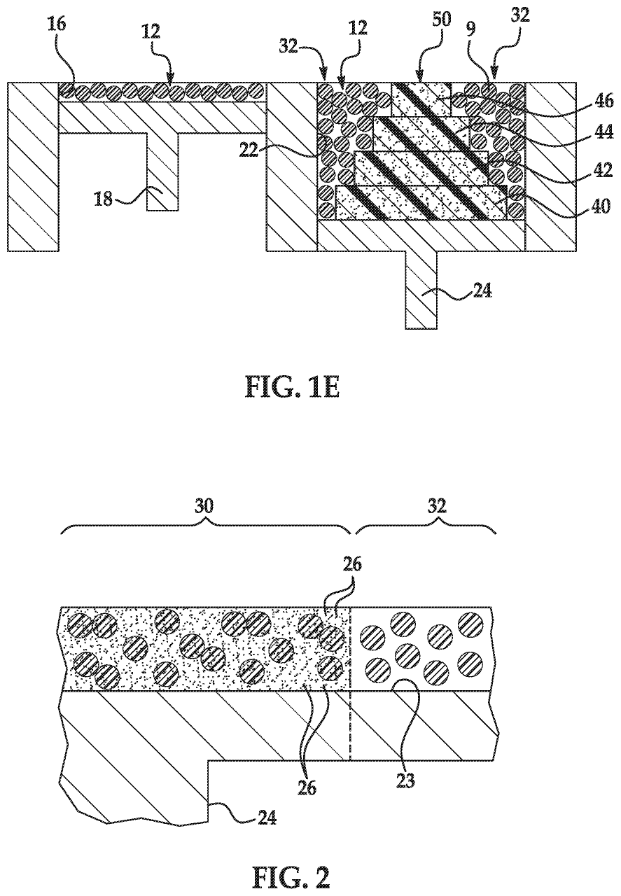

Referring now to FIG. 1A, a printing system 10 for forming a 3D object includes a supply bed 16 (including a supply of a build material composition 12), a delivery piston 18, a roller 20, a fabrication bed 22 (having a contact surface 23), and a fabrication piston 24. While not shown, the printing system 10 may also include a central fabrication/build bed and two side supply beds. As an example, a first supply bed may be raised higher than the central fabrication bed, which is raised higher than the second supply bed. A roller may be moved in a suitable direction to push the build material composition 12 (from the first supply bed) onto the central fabrication bed, where excess build material composition 12 is pushed into the second supply bed (i.e., the supply bed at the lower position). In this example, the positioning of the beds and the process may be reversed.

In the printing system 10, each of the physical elements may be operatively connected to a central processing unit (CPU) 56 of the printing system 10 (see, e.g., FIG. 4). The CPU 56 (e.g., running computer readable instructions stored on a non-transitory, tangible computer readable storage medium) manipulates and transforms data represented as physical (electronic) quantities within the printing system's registers and memories 52 in order to control the physical elements to create the 3D object. The data for the selective delivery of the build material composition 12, the fusing agent 26, etc. may be derived from a model of the 3D object to be formed.

The delivery piston 18 and the fabrication piston 24 may be the same type of piston, but are programmed to move in opposite directions as indicated by up arrow 78 and down arrow 79 in FIG. 1A. In an example, when a first layer of the 3D object is to be formed, the delivery piston 18 may be programmed to push a predetermined amount of the build material composition 12 out of the opening in the supply bed 16, and the fabrication piston 24 may be programmed to move in the opposite direction of the delivery piston 18 in order to increase the depth of the fabrication bed 22.

The delivery piston 18 will advance enough so that when the roller 20 pushes the build material composition 12 into the fabrication bed 22 and onto the contact surface 23, the depth of the fabrication bed 22 is sufficient so that a layer 14 of the build material composition 12 may be formed in the fabrication bed 22. The roller 20 is capable of spreading the build material composition 12 into the fabrication bed 22 to form the layer 14, which is relatively uniform in thickness (as shown at reference number 38 in FIG. 1A). In an example, the thickness 38 of the layer 14 ranges from about 100 μm to about 150 μm, although thinner (e.g., 90 μm) or thicker (e.g., 160 μm) layers may also be used. In another example, the thickness of the layer 14 ranges from about 110 μm to about 150 μm.

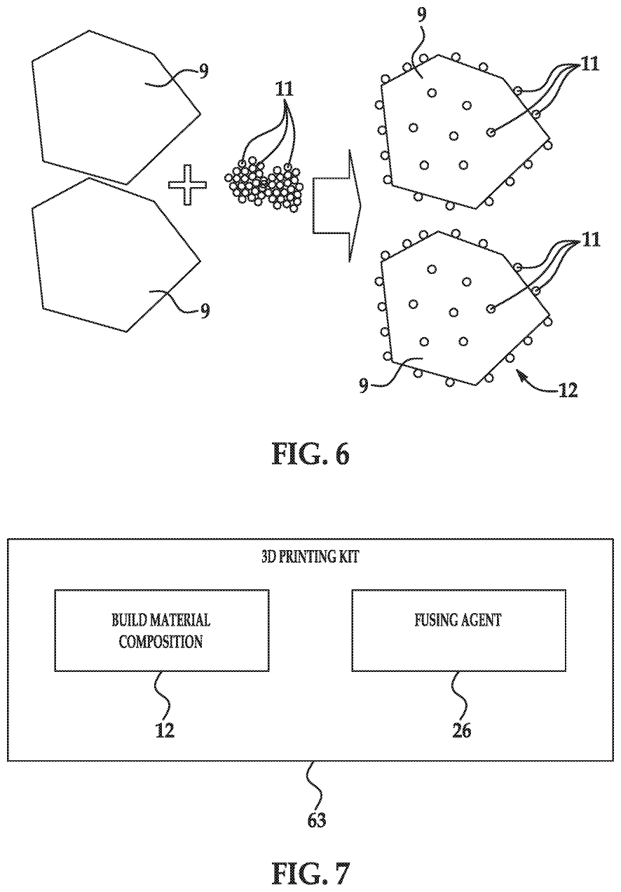

As depicted in FIG. 6, the build material composition 12 may include polymer particles 9 and an organometallic compound 11 dry-mixed with the polymer particle 9 to prevent Coulombic agglomeration of the build material composition 12 during pneumatic conveyance of the build material composition 12. It is to be understood that particles of the organometallic compound 11 may be much smaller than the particles of the polymer particles 9. In an example, the polymer particles 9 may have a size ranging from about 2 μm to about 200 μm; and the particles of the organometallic compound may have a size ranging from about 1 nm to about 500 nm. It is to be further understood that the particles of the organometallic compound 11 may be attached to surfaces of the polymer particles 9. As disclosed herein, the attachment of the particles of the organometallic compound 11 to the polymer particles 9 is not relatively strong. Without being held bound to any theory, it is believed that attachment is mainly from Van der Waals interactions and/or hydrophobic interactions. In some examples, amide groups in the polyamide backbone may coordinate to the (transition) metal in the organometallic compound 11.

It is to be understood that the roller 20 may be replaced by other tools, such as a blade that may be desirable for spreading different types of powders, or a combination of a roller and a blade. When applying the build material composition 12, a transversal speed of 0.1 inches per second to 100 inches per second may be used.

After the layer 14 of the build material composition 12 is introduced into the fabrication bed 22, the layer 14 may be exposed to heating as in FIG. 1B. Heating, e.g., by exposing to radiation 36 via radiation source 34 (FIG. 1D), is performed to pre-heat (but not melt/fuse) the build material composition 12, and thus it is desirable that the heating temperature be below the melting point of the polymer particles 9 of the build material composition 12. As such, the temperature selected for preheating will depend upon the polymer particle 9 that is used. As examples, the preheating temperature may be from about 5° C. to about 50° C. below the melting point of the build material composition 12. In an example, the preheating temperature ranges from about 85° C. to about 100° C. In another example, the preheating temperature ranges from about 130° C. to about 180° C. In yet another example, the preheating temperature ranges from about 150° C. to about 160° C.

Preheating the layer 14 of the build material composition 12 may be accomplished using any suitable heat source that exposes all of the build material composition 12 in the fabrication bed 22 to the heat. Examples of the heat source include an electromagnetic radiation source, such as a visible/infrared light source, microwave, etc., or a resistive heater(s) that is built into the fabrication bed 22 and the supply bed 16. Preheating may be used to ensure that the build material composition 12 is at a uniform temperature, which may help with improving cycle time.

After preheating the layer 14, the fusing agent 26 is selectively applied on at least a portion of the build material composition 12 in the layer 14, as shown in FIG. 1C. The fusing agent 26 enhances the absorbance of electromagnetic radiation 36, converts the absorbed electromagnetic radiation 36 to thermal energy, and promotes the transfer of the thermal heat to the build material composition 12 in contact with the fusing agent 26 (i.e., in the area(s)/portion(s) 30). In an example, the electromagnetic radiation 36, in the presence of the fusing agent 26, sufficiently elevates the temperature of the build material composition 12 in the area(s)/portion(s) 30 above the melting point(s), allowing coalescing (e.g., sintering, binding, fusing, curing, etc.) of at least the polymer particles 9 to take place.

FIG. 2 is a semi-schematic, cut-away cross-sectional view of a portion of FIG. 1C. It is to be understood that this cross-section is perpendicular to the contact surface 23 and is not the same as the cross-section of the pattern of the layer. The view in FIG. 2 illustrates some of the build material composition 12 on the contact surface 23 after the fusing agent 26 is applied thereon. As depicted, the fusing agent 26 penetrates into at least some of the voids between the particles of the build material composition 12 within the patterned portion 30. The fusing agent 26 is capable of enhancing curing (fusing, sintering, etc.) of the patterned portion 30 of the build material composition 12. In the area 32, the particles of the build material composition 12 have not had fusing agent 26 applied thereto.

As illustrated in FIG. 1C, the fusing agent 26 may be dispensed from an inkjet applicator 28 (e.g., a thermal inkjet printhead or a piezoelectric inkjet printhead). While a single inkjet applicator 28 is shown in FIG. 1C, it is to be understood that multiple inkjet applicators may be used that span the width of the fabrication bed 22. The inkjet applicator(s) 28 may be attached to a moving XY stage or a translational carriage (neither of which is shown) that moves the inkjet applicator(s) 28 adjacent to the fabrication bed 22 in order to deposit the fusing agent 26 in desirable area(s).

The inkjet applicator(s) 28 may be programmed to receive commands from the CPU 56 (see FIG. 4) and to deposit the fusing agent 26 according to a pattern of a cross-section for the layer of the 3D object that is to be formed. As used herein, the cross-section of the layer of the 3D object to be formed refers to the cross-section that is parallel to the contact surface 23. The inkjet applicator(s) 28 selectively applies the fusing agent 26 on those patterned portions 30 of the layer 14 that are to be fused to become one layer of the 3D object. As an example, if the 3D object is to be shaped like a cube or cylinder, fusing agent 26 will be deposited in a square pattern or a circular pattern (from a top view), respectively, on at least a patterned portion 30 of the layer 14 of the build material composition 12. In the example shown in FIG. 1C, the fusing agent 26 is deposited in a square pattern on the patterned portion 30 of the layer 14, and not on the unpatterned portions 32.

While a single fusing agent 26 fluid is shown in FIG. 1C, it is to be understood that a plurality of fluids may be used. For example, different fluids with different functions may be used as fusing agents. As an example, a fusing agent 26 may be used to provide color, another fusing agent 26 may be used to, in some instances, provide a catalyst, and yet another fusing agent 26 may be used to incorporate a binder for fusing enhancement.

As shown in FIG. 1D, the portions of the layer 14 to which the fusing agent 26 is not applied (i.e., unpatterned portion 32) do not coalesce/melt/fuse. The processes shown in FIGS. 1A through 1D may be repeated to iteratively build up several melted/fused layers and to form the 3D printed part. The build material composition 12 in the unpatterned portions 32 is removable from the 3D object 50. The build material composition 12 which is removed from the 3D object 50 may be recycled and reused in a subsequent 3D printing process as disclosed herein.

Referring to FIG. 1E, it is to be understood that the subsequently formed layers 42, 44, 46 may have any desirable shape and/or thickness and may be the same as, or different from any other layer 40, 42, 44, 46, depending upon the size, shape, etc. of the 3D object 50 that is to be formed.

As illustrated in FIG. 1E, as subsequent layers 42, 44, 46 have been formed, the delivery piston 18 is pushed closer to the opening of the supply bed 16, and the supply of the build material composition 12 in the supply bed 16 is diminished (compared, for example, to the supply of build material composition 12 in the supply bed 16 of FIG. 1A). The fabrication piston 24 is pushed further away from the opening of the fabrication bed 22 in order to accommodate the subsequent layer(s) of build material composition 12 and selectively applied fusing agent 26. Since at least some of the build material composition 12 remains unfused after each layer 40, 42, 44, 46 is formed, the 3D object 50 in the fabrication bed 22 is at least partially surrounded by the unfused build material composition 12.

When the 3D object 50 is formed, it may be removed from the fabrication bed 22, and exposed to a cleaning process that removes unfused build material composition 12 from the 3D object 50. In other examples, the 3D object 50 may remain in the fabrication bed 22 for at least a partial cleaning process. Some examples of the cleaning process include brushing, sonic cleaning, blasting, vacuuming, and combinations thereof. The unfused build material composition 12 remaining in the fabrication bed 22 may be reused depending, in part, on process conditions.

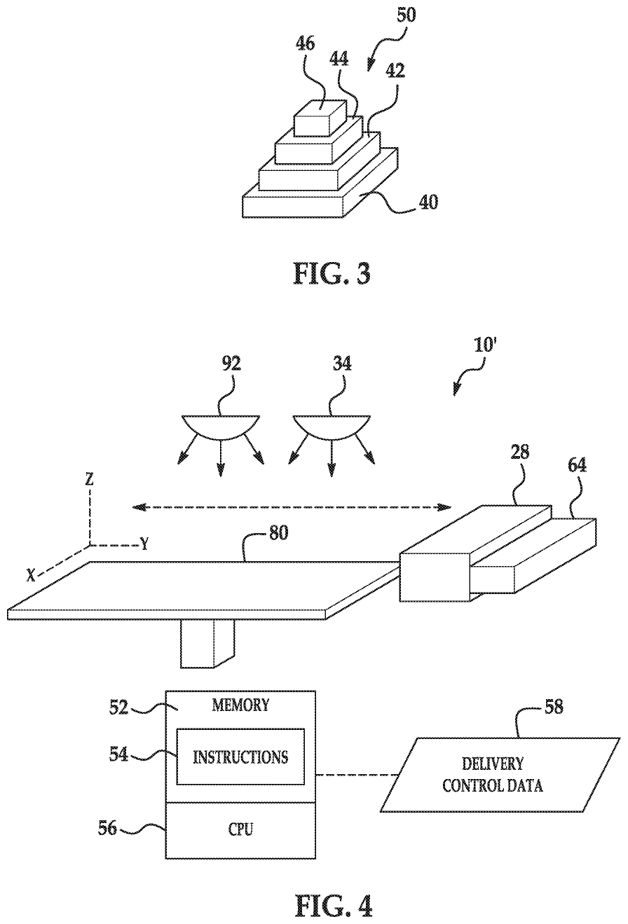

FIG. 3 illustrates a perspective view of the 3D object 50. Each of the layers 40, 42, 44, 46 includes coalesced polymer particles 9.

Referring now to FIG. 4, another example of the printing system 10′ is depicted. The printing system 10′ includes a central processing unit (CPU) 56 that controls the general operation of the printing system 10′. As an example, the central processing unit 56 may be a microprocessor-based controller that is coupled to a memory 52, for example via a communications bus (not shown). The memory 52 stores the computer readable instructions 54. The central processing unit 56 may execute the instructions 54, and thus may control operation of the printing system 10′ in accordance with the instructions 54.

In this example, the printing system 10′ includes the inkjet applicator 28 to selectively deliver/apply the fusing agent 26 to a layer 14 (not shown in this figure) of build material composition 12 provided on a support member 80. In an example, the support member 80 has dimensions ranging from about 10 cm by 10 cm up to about 100 cm by 100 cm, although the support member 80 may have larger or smaller dimensions depending upon the 3D object 50 that is to be formed.

The central processing unit 56 controls the selective delivery of the fusing agent 26 to the layer 14 of the build material composition 12 in accordance with delivery control data 58.

In the example shown in FIG. 4, it is to be understood that the inkjet applicator 28 is a printhead, such as a thermal printhead or a piezoelectric inkjet printhead. The inkjet applicator 28 may be a drop-on-demand printhead or a continuous drop printhead.

The inkjet applicator 28 may be used to selectively deliver the fusing agent 26. The fusing agent 26 includes an aqueous vehicle (such as water), and, in some instances, other suitable components, such as a co-solvent, a surfactant, etc., to facilitate its delivery via the inkjet applicator 28.

In one example, the inkjet applicator 28 may be selected to deliver drops of the fusing agent 26 at a resolution ranging from about 300 dots per inch (DPI) to about 1200 DPI. In other examples, the inkjet applicator 28 may be selected to be able to deliver drops of the fusing agent 26 at a higher or lower resolution.

The inkjet applicator 28 may include an array of nozzles through which the inkjet applicator 28 is able to selectively eject drops of fluid. In one example, each drop may be in the order of about 10 pico liters (pl) per drop, although it is contemplated that a higher or lower drop size may be used. In some examples, inkjet applicator 28 is able to deliver variable size drops.

The inkjet applicator 28 may be an integral part of the printing system 10′, or it may be user replaceable. When the inkjet applicator 28 is user replaceable, it may be removed from and inserted into a suitable distributor receiver or interface module (not shown).

In another example of the printing system 10′, a single inkjet printhead may be used to selectively deliver different fusing agents 26. For example, a first set of printhead nozzles of the printhead may be configured to deliver one of the fusing agents 26, and a second set of printhead nozzles of the printhead may be configured to deliver another of the fusing agents 26.

As shown in FIG. 4, the inkjet applicator 28 has a length that enables it to span the whole width of the support member 80 in a page-wide array configuration. In an example, the page-wide array configuration is achieved through a suitable arrangement of multiple inkjet applicators 28. In another example, the page-wide array configuration is achieved through a single inkjet applicator 28 with an array of nozzles having a length to enable them to span the width of the support member 80. In other examples of the printing system 10′, the inkjet applicator 28 may have a shorter length that does not enable them to span the whole width of the support member 80.

While not shown in FIG. 4, it is to be understood that the inkjet applicator 28 may be mounted on a moveable carriage to enable it to move bi-directionally across the length of the support member 80 along the illustrated Y-axis. This enables selective delivery of the fusing agent 26 across the whole width and length of the support member 80 in a single pass. In other examples, the inkjet applicator 28 may be fixed while the support member 80 is configured to move relative thereto.

As used herein, the term ‘width’ generally denotes the shortest dimension in the plane parallel to the X and Y axes shown in FIG. 4, and the term ‘length’ denotes the longest dimension in this plane. However, it is to be understood that in other examples the term ‘width’ may be interchangeable with the term ‘length’. As an example, the inkjet applicator 28 may have a length that enables it to span the whole length of the support member 80 while the moveable carriage may move bi-directionally across the width of the support member 80.

In examples in which the inkjet applicator 28 has a shorter length that does not enable them to span the whole width of the support member 80, the inkjet applicator 28 may also be movable bi-directionally across the width of the support member 80 in the illustrated X axis. This configuration enables selective delivery of the fusing agent 26 across the whole width and length of the support member 80 using multiple passes.

The inkjet applicator 28 may include therein a supply of the fusing agent 26, or may be operatively connected to a separate supply of the fusing agent 26.

As shown in FIG. 4, the printing system 10′ also includes a build material distributor 64. This build material distributor 64 is used to provide the layer (e.g., layer 14) of the build material composition 12 on the support member 80. Suitable build material distributors 64 may include, for example, a wiper blade, a roller, or combinations thereof.

The build material composition 12 may be supplied to the build material distributor 64 from a hopper or other suitable delivery system. In the example shown, the build material distributor 64 moves across the length (Y axis) of the support member 80 to deposit a layer of the build material composition 12. As previously described, a first layer of build material composition 12 will be deposited on the support member 80, whereas subsequent layers of the build material composition 12 will be deposited on a previously deposited (and solidified) layer.

It is to be further understood that the support member 80 may also be moveable along the Z axis. In an example, the support member 80 is moved in the Z direction such that as new layers of build material composition 12 are deposited, a predetermined gap is maintained between the surface of the most recently formed layer and the lower surface of the inkjet applicator 28. In other examples, however, the support member 80 may be fixed along the Z axis, and the inkjet applicator 28 may be movable along the Z axis.

Similar to the printing system 10, the printing system 10′ also includes the radiation source 34 to apply energy when desired to the deposited layer of build material composition 12 and the selectively applied fusing agent 26. Any of the previously described radiation sources 34 may be used. In an example, the radiation source 34 is a single energy source that is able to uniformly apply energy to the applied materials, and in another example, radiation source 34 includes an array of energy sources to uniformly apply energy to the deposited materials.

In the examples disclosed herein, the radiation source 34 may be configured to apply energy in a substantially uniform manner to the whole surface of the deposited build material composition 12. This type of radiation source 34 may be referred to as an unfocused energy source. Exposing the entire layer to energy simultaneously may help increase the speed at which a 3D object 50 may be generated.

While not shown, it is to be understood that the radiation source 34 may be mounted on the moveable carriage or may be in a fixed position.

The central processing unit 56 may control the radiation source 34. The amount of energy applied may be in accordance with delivery control data 58.

The printing system 10′ may also include a pre-heater 92 that may be used to pre-heat the support member 80 and/or the deposited build material composition 12 (as described above). Still further, the printing system 10′ may include tools and components to perform the cleaning previously described.

In examples of the present disclosure, the build material composition 12 may be conveyed to the supply bed 16 via a pneumatic powder conveyance device. As used herein, pneumatic powder conveyance means using a contained, flowing airstream to carry pneumatic powder from one place to another place. A vacuum conveyance system is an example of a pneumatic powder conveyance device. The build material composition 12 may be a mixed build material composition 72 that is a mixture of fresh build material composition 51 and recycled build material composition 62 that has been gleaned from an unpatterned portion 32 during a previous 3D printing process.

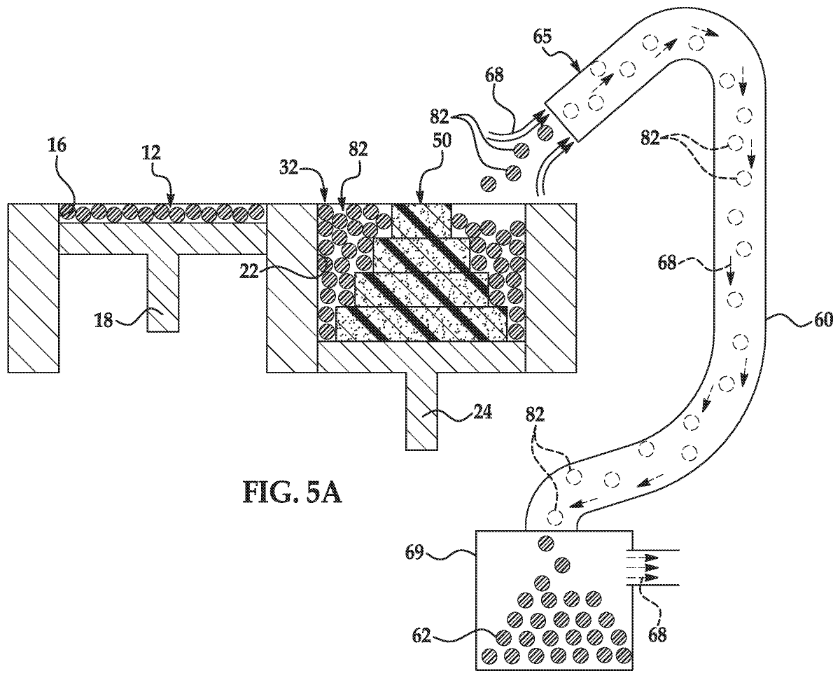

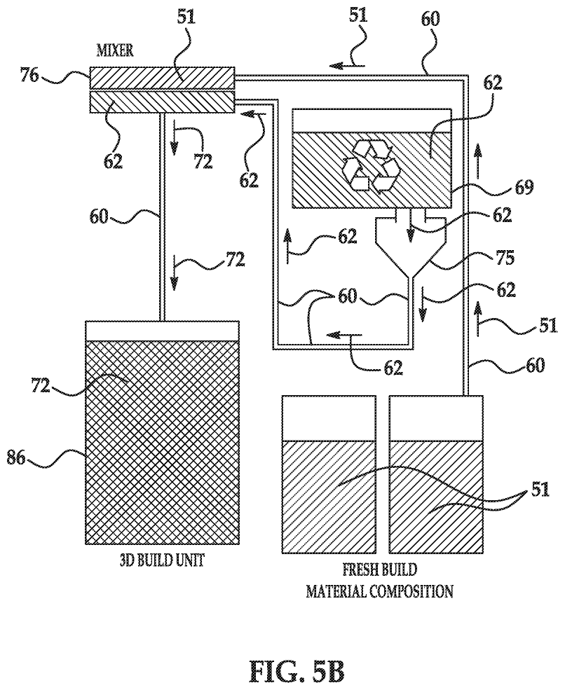

As depicted in FIG. 5A, the unpatterned build material composition 82 may be removed from the 3D object 50 and the fabrication bed 22 using a vacuum system 65. The vacuum system 65 is a pneumatic conveyor. In FIG. 5A and FIG. 5B, pneumatic conveyor tubes are indicated by reference numeral 60. In some examples, the pneumatic conveyor tubes 60 may be flexible vacuum hoses. In other examples, the pneumatic conveyor tubes 60 may be rigid vacuum conduit or pressurized air tubes. The vacuum system 65 carries the unpatterned build material composition 82 along with air 68 or any suitable gas or gas mixture to be collected in a container for further processing. For example, the unpatterned build material composition 82 may be pneumatically collected in a recycling tank 69. As used herein, “recycled build material composition” 62 means the unpatterned build material composition 82 that has been collected (e.g., in a recycling tank, container, or open pile). As used herein, “recyclable powdered build material” means the unpatterned build material composition 82 and the recycled build material composition 62. As used herein, “fresh build material composition” means build material composition that has not been through a 3D print cycle. A 3D print cycle includes depositing a build material composition, and coalescing at least a portion of the build material composition to form a layer of a three-dimensional object. Although fresh build material composition 51 may be technically capable of being recycled, as used herein, “recyclable powdered build material” excludes fresh build material composition 51. The recycled build material composition 62 may be sieved (see sieve 75 in FIG. 5B) and pneumatically conveyed to a mixer 76 to be mixed with fresh build material composition 51 to yield mixed build material composition 72 having any suitable ratio of the recycled build material composition 62 and the fresh build material composition 51. For example the mixed build material composition 72 may have from 0.1% to 99.9% recycled build material composition. When no recycled build material composition 62 is present, then the build material composition 12 is 100% fresh build material composition 51. When no fresh build material composition 51 is present, then the build material composition 12 is 100% recycled build material composition 62. In the present example, recycled build material composition 62 means the unpatterned build material composition 82 that may have been sieved, but not otherwise chemically, thermally, or electrically treated after being removed from the 3D object 50 during a previous 3D printing process. The mixed build material composition 72 may be conveyed to a build unit 86, and loaded into the build unit 86 for 3D printing a subsequent 3D object 50.

During pneumatic conveyance, polymer particles in some 3D build materials may experience contact electrification. The contact electrification may be due to multiple wall impacts experienced by the polymer particles during pneumatic conveyance. The contact electrification may cause a substantial electrical charge to build on the pneumatically conveyed powder particles. The substantial electrical charge may remain at effective charge levels on the powder particles for a duration long enough to induce the powder particles to self-assemble into coulombic agglomerates. The self-assembly into coulombic agglomerates creates inhomogeneous densification in the flow of the build material. The coulombic agglomerates may obstruct proper inertial flow in the pneumatic conveying system. For example, the coulombic agglomerates may create inhomogeneous densifications which may deleteriously affect flow of the build material in a 3D printing system. For example, a clog may develop in the pneumatic conveyor; or build material flow through the pneumatic conveyor may ebb and surge. The coulombic agglomerates may cause degradation in uniformity of the thickness and density of the build material in the layer as the build material is spread for 3D printing.

Without being held bound to any theory, it is believed that there are two causal modalities for coulombic agglomeration in some build material powders. The first causal modality is based on thermally induced embedding of hydrophilic flow aids into a polyamide powder particle. Some polyamide powders used for 3D printing with a fusing agent may have organic ammonium salt and amine based anti-static additives. Hydrophilic flow aids absorb water. The effectiveness of the anti-static property of the ammonium salt and amine compounds depends, at least in part, on surface moisture. Hydrophilic flow aids provide sufficient water vapor which maintains the effectiveness of the organic ammonium salt and amine based anti-static additives during pneumatic conveyance. However, if the polyamide powder particles are brought above their glass transition temperature, the flow aids may sink into the polyamide powder particle and become at least partially embedded. Full or partially embedded flow aids may reduce or obviate the effectiveness of the anti-static additives that depend on surface moisture, which can lead to particle agglomeration.

There may be a second causal modality for coulombic agglomeration in some polyamide powder particles with hydrophobic flow aids. Such hydrophobic flow aids may also be called “anti-caking” additives. The powder build material composition that has hydrophobic flow aids may further include an anti-static additive such as quaternary ammonia and amines. Further, mixtures of both hydrophilic and hydrophobic anti-static compounds may be included in the same powder build material composition. However, some of these anti-static compounds can degrade at fabrication bed temperatures, which can lead to particle agglomeration.

During some 3D printing processes some of the build material powder in the print bed is patterned and becomes part of the 3D object, with a remainder of the build material powder being unused and potentially available for recycling and reuse in 3D printing a subsequent 3D object. The 3D printing and build material recycling process may expose at least a portion of the recycled build material powder to high temperatures and levels of humidity that may degrade anti-static properties of the recycled build material. The recycled build material may be pneumatically conveyed. As stated above, during pneumatic conveyance, polymer particles in some 3D build materials may experience contact electrification if the anti-static properties of the recycled build material have been diminished by high temperatures and levels of humidity during 3D printing operations. The contact electrification may cause the powder particles to self-assemble into coulombic agglomerates that create inhomogeneous densification in the flow of the build material.

As disclosed herein, some organometallic compounds can be used as anti-static additives in 3D build material powders. As disclosed herein, the 3D build material powders that include the organometallic compounds are not affected by operational humidity and temperature ranges near the powder bed. Thus, including these organometallic compounds as anti-static additives may prevent recycled build material powder from self-assembly into coulombic agglomerates.

In an example of the present disclosure, as depicted in FIG. 7, a three-dimensional (3D) printing kit 63 includes a build material composition 12 and a fusing agent 26. The build material composition 12 includes polymer particles 9 and an organometallic compound 11 dry-mixed with the polymer particles to prevent Coulombic agglomeration of the build material composition 12 during pneumatic conveyance of the build material composition 12. The fusing agent 26 is to be applied to at least a portion 30 of the build material composition 12 during 3D printing. The fusing agent 26 includes an energy absorber to absorb electromagnetic radiation to coalesce the polymer particles 9 in the at least the portion 30.

In some examples of the present disclosure, the organometallic compound 11 may be present in an amount from about 0.01 weight percent (wt. %) to about 10 wt. % based on a total weight of the build material composition 12. In other examples of the present disclosure, the organometallic compound 11 may be present in an amount from about 0.1 weight percent (wt. %) to about 5 wt. % based on the total weight of the build material composition 12. In other examples of the present disclosure, the organometallic compound 11 may be present in an amount from about 1 weight percent (wt. %) to about 10 wt. % based on the total weight of the build material composition 12.

In examples of the present disclosure, the polymer particles 9 may be selected from the group consisting of polyamides, polyethylene, polyethylene terephthalate (PET), polyacetals, polypropylene, polyesters, polyoxymethylene (POM), polyether ether ketone (PEEK), polyetherketoneketone (PEKK), polyphenylene sulfide (PPS), polytetrafluoroethylene (PTFE), polyvinylidene fluoride (PVDF), and combinations thereof.

As disclosed herein, the organometallic compound 11 may be any suitable organometallic compound. In some examples, the organometallic compound 11 is selected from the group consisting of a trineoalkoxy amino zirconate, a trineoalkoxy sulfonyl zirconate, and combinations thereof. In the present disclosure, trineoalkoxy amino zirconate, and trineoalkoxy sulfonyl zirconate may be collectively referred to as TNZs.

As used herein, TNZs refer to compounds having the following formulas:

[(CH₃)₃CH₂O]₃ZrA or B (I)

[(CH₃)₃—R—CH₂O]₃ZrA or B (II)

wherein R is a monovalent alkyl, alkenyl, alkynyl, aralkyl, aryl or alkaryl group having up to 20 carbon atoms or a halogenated- or ether-substituted derivative thereof; and A is either an oxyalkylamino (—O—R₄—N(R₅)(R₆)) or an oxyaryl amino (—OArN(R₅)(R₆)) group, and B is an arylsulfonyl ((ArS(O)₂—O)—, R—ArS(O)₂—O—, or Ar—RS(O)₂—O—) or an alkyl sulfonyl (R—S(O)₂O—) group.

In examples, R may contain up to three ether oxygen or halogen substituents, provided the total number of carbon atoms for each such R group does not exceed 20, inclusive of the carbon atoms contained in substituent portions. In an example, the R group in the alkyl sulfonyl group contains from 1 to 8 carbon atoms.

In examples, R₄ may be a divalent alkylene group which many contain, in the chain, oxygen and nitrogen atoms, e.g., a-C₂ H₄ NHC₂ H₄— group.

In examples, R₅ and R₆ may be hydrogen or hydrocarbyl groups as defined for R above. In some examples, R₅ and R₆ are hydrogen, i.e., the terminal amino group has primary functionality as opposed to secondary or tertiary.

Ar, in the above formulas, may be a monovalent aryl or alkaryl group having from 6 to about 20 carbon atoms, optionally containing up to 3 ether oxygen substituents, and substituted derivatives thereof, wherein the substitutions are up to a total of three halogens or amino groups having the formula NR₈ R₉ wherein R₈ and R₉ are each hydrogen, an alkyl group having 1 to 12 carbon atoms, an alkenyl group having from 2 to 8 carbon atoms, a cycloalkyl group having from 3 to 12 carbon atoms, and an aryl group having from 6 to 12 carbon atoms. In some examples, Ar is a phenylene group having a long chain alkyl substitution having from 8 to 18 carbon atoms.

While the use of TNZs to provide anti-static properties to articles made from various polymers (e.g., plastic computer housings) has been previously disclosed; the inventors of the present disclosure have fortuitously and serendipitously discovered that TNZs may provide anti-static properties to polymer powders, particularly polymer powders that may be used as build material composition for 3D printing, and even more particularly, 3D printing powders that are recycled and pneumatically conveyed. The anti-static properties provided to the build material composition prevents Coulombic agglomeration of the build material composition while the build material composition is in a powdered state.

In other examples, the organometallic compound 11 may include a polymer with a conjugated pi-orbital backbone. In examples of the present disclosure, the polymer with the conjugated pi-orbital backbone may be any suitable polymer with a conjugated pi-orbital backbone. In some examples, the polymer with the conjugated pi-orbital backbone is selected from the group consisting of poly(metalyne), poly(metallophthalocyanines), metal poly(benzodithiolene), poly(metalloethylene terathiolate), poly(metal tetrathio-oxalate), and combinations thereof. It is to be understood that poly(metalyne), poly(metallophthalocyanines), metal poly(benzodithiolene), poly(metalloethylene terathiolate), and poly(metal tetrathio-oxalate) are individual polymer classes.

Without being held bound to any theory, it is believed that the TNZs and classes of polymers with conjugated pi-orbital backbones provide anti-static properties independently of moisture. Unlike organic amines and similar components, the TNZs and the classes of polymers with conjugated pi-orbital backbones do not rely on the presence of surface moisture. In some examples of the present disclosure, the build material composition 12 may be relatively dry at certain stages of a 3D printing process. Recycled build material compound may also tend to be very dry in 3D printing processes as disclosed herein. Therefore, the TNZs and classes of polymers with conjugated pi-orbital backbones as disclosed herein may advantageously provide anti-static capabilities to the build material composition under dry conditions where moisture dependent additives like organic amines have diminished anti-static capabilities.

As depicted in FIG. 6, examples of the build material composition 12 of the present disclosure may be made by dry-mixing a powdered organometallic compound 11 with a polymer particle powder 9. In some examples, the powdered organometallic compound 11 may be dry-mixed with the polymer particle powder 9 in a high-shear mixer until the organometallic compound 11 is substantially uniformly distributed on surfaces of the polymer particles 9.

As used herein, a high-shear mixer (HSM) is a mixer that includes a rotor or impeller and a stator. HSMs may have a single rotor/stator combination, or an array of rotors and stators. Flowable, dry material (powder, grain, etc.) undergoes shear when one volume of flowable material travels with a different velocity relative to an adjacent volume. An HSM uses a motor-driven rotating impeller or high-speed rotor, to “work” the flowable material, creating flow and shear. The tip velocity, or speed of the flowable material at the outside diameter of the rotor, will be higher than the speed at the center of the rotor, thereby creating shear. A gap between the rotor and the stator forms a high-shear zone for the flowable material as the material exits the rotor. The rotor and stator together may be referred to as a mixing head, or generator. In examples, HSMs can be used to produce batches of mixed product in a tank. In other examples, HSMs may be configured to operate inline. An inline HSM may have a rotor—stator array contained in a housing with an inlet at one end of the housing and an outlet at the opposite end of the housing. The materials to be mixed by an inline HSM are drawn through the rotor-stator array in a continuous stream. HSMs are available from, for example, Charles Ross & Son Company, Hauppauge, N.Y.

As used herein, “substantially uniformly distributed on surfaces of the polymer particles” means that the observed (sampled) probability of finding a particle of the powdered organometallic compound 11 on a surface of a polymer particle 9 is within +/−10 percent of the average probability of finding a particle of the powdered organometallic compound 11 on a surface of a polymer particle 9 throughout the population of polymer particles 9. It is to be understood that a mixture with low uniformity of distribution may have portions of the mixture without an effective amount of the powdered organometallic compound 11 distributed therein, thereby increasing a potential for agglomeration in those portions of the mixture. Therefore, “substantially uniformly distributed on surfaces of the polymer particles” as used herein means an effective amount of the powdered organometallic compound 11 is distributed throughout the build material composition 12 so as to prevent Coulombic agglomeration of the build material composition 12 throughout the build material composition 12 during pneumatic conveyance of the build material composition 12. In some examples, preventing Coulombic agglomeration of the build material composition 12 results in less than 1 Coulombic agglomeration-related defect per liter of cured build material composition. In other examples, preventing Coulombic agglomeration of the build material composition 12 results in less than 0.1 Coulombic agglomeration-related defect per liter of cured build material composition.

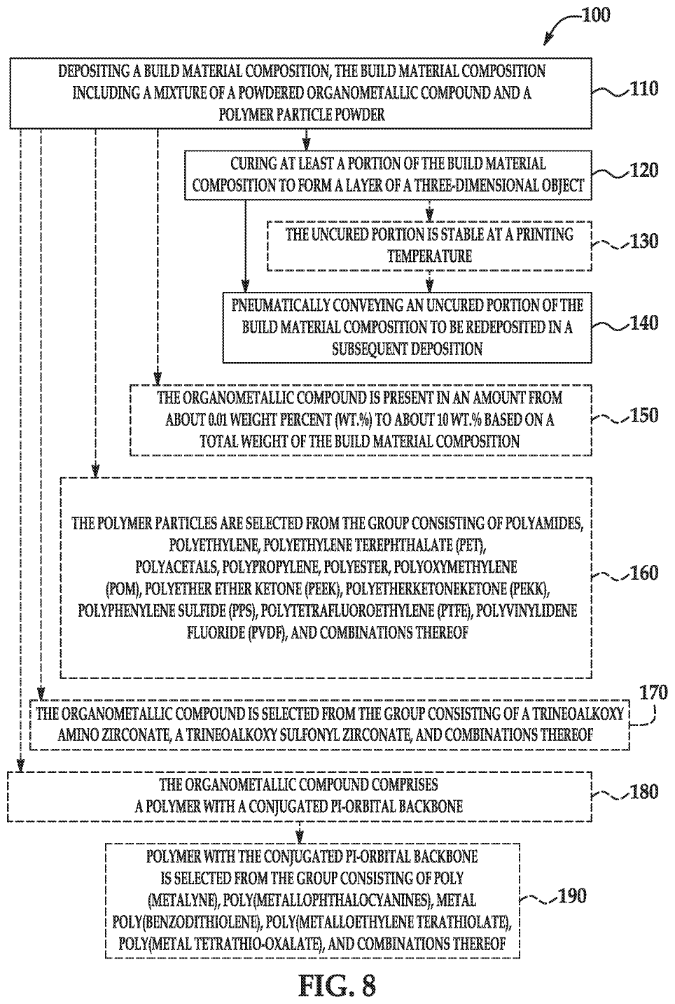

As depicted in FIG. 8, in examples of the present disclosure, a three-dimensional (3D) printing method 100 includes “depositing a build material composition, the build material composition including a mixture of a powdered organometallic compound and a polymer particle powder” as depicted in Box 110. As depicted in Box 120, the method 100 includes “curing at least a portion of the build material composition to form a layer of a three-dimensional object.” The method 100 further includes, as depicted in Box 140, “pneumatically conveying an uncured portion of the build material composition to be redeposited in a subsequent deposition.”

In FIG. 8, a box with a dashed outline indicates an element of the method 100 that may be included. As depicted at box 130, in some examples, “the uncured portion is stable at a printing temperature.”

As depicted in box 150, in some examples, “the organometallic compound is present in an amount from about 0.01 weight percent (wt. %) to about 10 wt. % based on the total weight of the build material composition.”

As depicted in box 160, in some examples, “the polymer particles are selected from the group consisting of polyamides, polyethylene, polyethylene terephthalate (PET), polyacetals, polypropylene, polyester, polyoxymethylene (POM), polyether ether ketone (PEEK), polyetherketoneketone (PEKK), polyphenylene sulfide (PPS), polytetrafluoroethylene (PTFE), polyvinylidene fluoride (PVDF), and combinations thereof.”

As depicted in box 170, in some examples, “the organometallic compound is selected from the group consisting of a trineoalkoxy amino zirconate, a trineoalkoxy sulfonyl zirconate, and combinations thereof.”

As depicted in box 180, in some examples, “the organometallic compound comprises a polymer with a conjugated pi-orbital backbone.”

As depicted in box 190, in some examples, “the polymer with the conjugated pi-orbital backbone is selected from the group consisting of poly(metalyne), poly(metallophthalocyanines), metal poly(benzodithiolene), poly(metalloethylene terathiolate), poly(metal tetrathio-oxalate), and combinations thereof.”

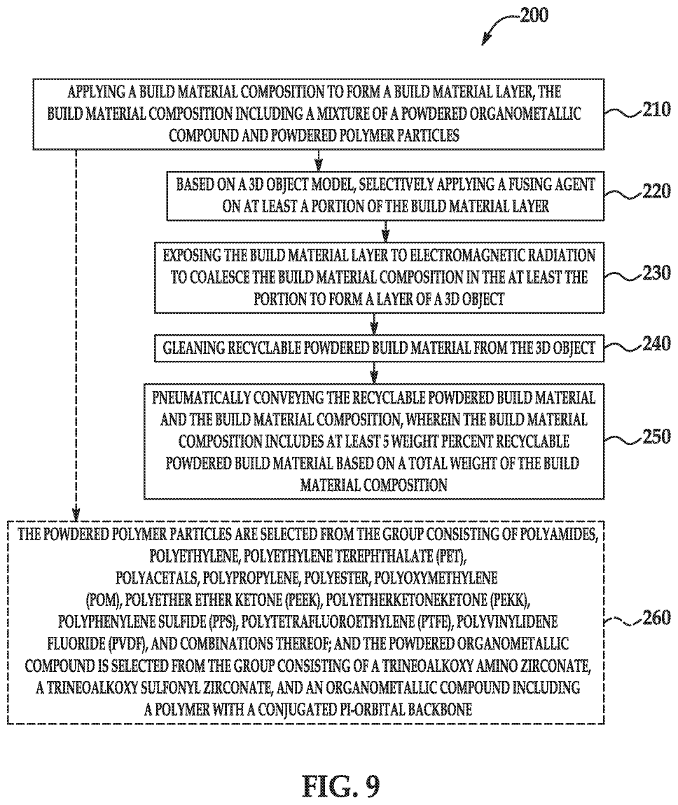

As depicted in FIG. 9, in examples of the present disclosure, a method for three-dimensional (3D) printing 200 includes “applying a build material composition to form a build material layer, the build material composition including a mixture of a powdered organometallic compound and powdered polymer particles” as depicted in Box 210. As depicted in Box 220, the method 200 includes “based on a 3D object model, selectively applying a fusing agent on at least a portion of the build material layer.” The method 200 further includes, as depicted in Box 230, “exposing the build material layer to electromagnetic radiation to coalesce the build material composition in the at least the portion to form a layer of a 3D object.” The method 200 further includes, as depicted in Box 240, “gleaning recyclable powdered build material from the 3D object.” As depicted in Box 250, the method 200 also includes “pneumatically conveying the recyclable powdered build material and the build material composition, wherein the build material composition includes at least 5 weight percent recyclable powdered build material based on the total weight of the build material composition.”

In FIG. 9, a box with a dashed outline indicates an element of the method 200 that may be included. In examples of the method 200, as depicted in box 260, “the powdered polymer particles are selected from the group consisting of polyamides, polyethylene, polyethylene terephthalate (PET), polyacetals, polypropylene, polyester, polyoxymethylene (POM), polyether ether ketone (PEEK), polyetherketoneketone (PEKK), polyphenylene sulfide (PPS), polytetrafluoroethylene (PTFE), polyvinylidene fluoride (PVDF), and combinations thereof; and the powdered organometallic compound is selected from the group consisting of a trineoalkoxy amino zirconate, a trineoalkoxy sulfonyl zirconate, an organometallic compound including a polymer with a conjugated pi-orbital backbone, and combinations thereof.”

In examples of the printing methods 100, 200, the uncured portion is stable at a printing temperature (as depicted in box 130 in FIG. 8). In other words, both the uncured polymer particle powder and the powdered organometallic compound are not melted or degraded at the maximum temperature that is reached during 3D printing. The polymer particle powder may remain stable at a temperature below its melting point. The powdered organometallic compound may remain stable at even higher temperatures, such as 400° C. As used herein, “stable” means that the powdered organometallic compound does not disintegrate, and continues to function in the build material composition to prevent Coulombic agglomeration of the build material composition during pneumatic conveyance of the build material composition. The stability of the uncured portion enables the uncured portion to be recycled, and in particular, the stability of the powdered organometallic compound enables the uncured portion to be spread into substantially uniform layers in subsequent 3D printing processes.

In examples, a 3D printing process may expose the build material composition 12 in the fabrication bed to temperatures over 200° C. Such temperatures may deteriorate anti-static capabilities of some existing anti-static additives (e.g., organic amines) and result in Coulombic agglomeration of recycled build material composition. However, in examples of the present disclosure, the organometallic compound added to the polymer particles in the build material composition 12 remains stable at 3D printing temperatures. For example, TNZs may be stable up to about 440° C., which is above the sinter/cure temperature of some of the polymers that may be used in 3D printing as disclosed herein.

To further illustrate the present disclosure, an example is given herein. It is to be understood that this example is provided for illustrative purposes and is not to be construed as limiting the scope of the present disclosure.

### EXAMPLE

The following example shows laboratory verification that a sample of a 3D build material powder can be electrified during pneumatic conveyance; and that more electrified samples of the 3D build material powder experience more agglomeration than less electrified samples of the 3D build material powder.

Build material powder

| | |
|---|---|
| Build material 1 | Recycled polyamide powder |
| Build material 2 | Fresh polyamide powder |

First, the powders were dried using a Sherwood Tornado M501 Fluid Bed Dryer. Temperature setting: 90° C. Time setting: 20 minutes. Fluidization pressure was adjusted until powder eruptions were observed. Moisture content of the powders was measured using an Ohaus MB120 Moisture Analyzer.

The powder was electrified by using a vacuum cleaner and vacuum attachment hose. A DUST DEPUTY™ cyclone separator was attached in-line with the vacuum attachment hose to collect the powder. The DUST DEPUTY™ cyclonically separates the powder from the air-stream before reaching the vacuum's filter. The DUST DEPUTY™ may have contributed to the electrification of the powder.

A sample of Build Material 1 was ion enhanced by tumbling the powder over a 5000 Volt electrode for 10 minutes.

Measurement Method:

This method used the following screens: 125 μm, 250 μm, 355 μm

The pan and screens were weighed individually. The pan and the screens were stacked in the following order from bottom to top: (pan, 125 μm, 250 μm, 355 μm). Eight heaping tablespoons of prepared Build Material powder were added. The stack was vibrated with a Haver & Boeker 59302 OECDE Sieve Shaker for 15 minutes at 0.5 mm amplitude. Each pan and sieve was weighed individually with powder.

Build Material 1 - 0.25% Moisture Content - Trial 1

| | W before | W after | Difference | % Total |
|---|---|---|---|---|
| Screen | [g] | [g] | [g] | Weight |
| Pan | 412.39 | 463.34 | 50.95 | 91.47 |
| 125 μm | 363.19 | 366.73 | 3.54 | 6.36 |
| 250 μm | 372.54 | 373.48 | 0.94 | 1.69 |
| 355 μm | 384.64 | 384.91 | 0.27 | 0.48 |

| | | |
|---|---|---|
| Total Powder Weight | 55.70 | |
| Crystal Agglomerates as % | | 8.53 |
| of Total Weight | | |

Build Material 1 - 0.25% Moisture Content - Trial 2

| | W before | W after | Difference | % Total |
|---|---|---|---|---|
| Screen | [g] | [g] | [g] | Weight |
| Pan | 412.37 | 463.34 | 61.03 | 90.48 |
| 125 μm | 363.13 | 366.73 | 4.12 | 6.13 |
| 250 μm | 371.54 | 373.17 | 1.63 | 2.43 |
| 355 μm | 384.02 | 384.42 | 0.40 | 0.60 |

| | | |
|---|---|---|
| Total Powder Weight | 67.18 | |
| Crystal Agglomerates as % | | 9.15 |
| of Total Weight | | |

Build Material 1 - 0.25% Moisture Content - Trial 3

| | W before | W after | Difference | % Total |
|---|---|---|---|---|
| Screen | [g] | [g] | [g] | Weight |
| Pan | 412.37 | 473.41 | 61.04 | 90.86 |
| 125 μm | 363.14 | 366.94 | 3.80 | 5.66 |
| 250 μm | 372.54 | 375.98 | 3.44 | 5.12 |
| 355 μm | 384.05 | 385.33 | 1.28 | 1.91 |

| | | |
|---|---|---|
| Total Powder Weight | 69.56 | 67.18 |
| Crystal Agglomerates as % | | 9.14 |
| of Total Weight | | |

Build Material 1 - 0.25% Moisture Content - Summary

| | | |
|---|---|---|
| Crystal Agglomerates as % of Total Weight | Mean | 8.94 |
| | Std. Dev. | 0.36 |

Similar trials were run for each of the other samples. For brevity, the summaries are tabulated below, and the details have been omitted.

| | | | Mean Crystal | |
|---|---|---|---|---|
| | Moisture | Coulombic | Agglomerates | |
| | Content | Agglomeration | as % of Total | |
| Powder | (%) | Tendency | Weight | St. Dev. |
| Build | 0.25 | High | 8.94 | 0.36 |
| Material 1 | | | | |
| Build | 0.29 | Low | 1.76 | 0.60 |
| Material 2 | | | | |
| Build | 0.6 | Low | 1.16 | 0.69 |
| Material 1 | | | | |
| Build | 0.26 | High+ | 10.68 | 0.23 |
| Material 1 - | | | | |
| Ion | | | | |
| Enhanced | | | | |

When Build Material 1 had a higher moisture content (0.6%), there was less agglomeration than when Build Material 1 had a lower moisture content (0.25, 0.26). This supports a hypothesis that the anti-static properties of Build Material 1 are enhanced by moisture. Build material 1 (recycled build material) had much more agglomeration after attempted electrification than Build material 2 (fresh build material).

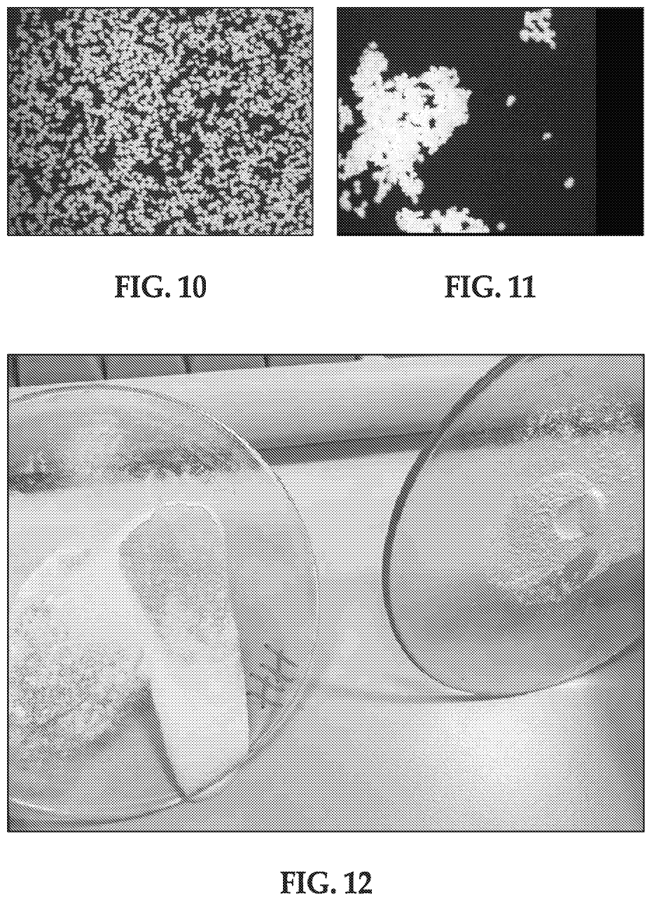

FIG. 10 is an optical photomicrograph showing Build Material 1 before electrification using the DUST DEPUTY™. FIG. 11 is an optical photomicrograph showing Build Material 1 after electrification using the DUST DEPUTY. FIG. 12 is a photograph showing Build Material 1 before (left) and after (right) electrification using the DUST DEPUTY™. It is noted that before the electrification, the particles were separate (as shown in FIG. 10), and the particles were able to flow off of the transparent disk when the disk was tilted up on the edge of the disk (FIG. 12, left). After electrification, the particles agglomerated (as shown in FIG. 11), and the particles did not flow when the transparent disk was tilted up on the edge of the disk (FIG. 12, right).

### Conclusions from Example

The results support the hypothesis that a dry 3D build material powder can be electrified during pneumatic conveyance, and that more electrified 3D build material powder experiences more agglomeration than less electrified 3D build material powder.

It is believed that the anti-stat disclosed herein will help to reduce electrification during pneumatic conveyance, and thus will also reduce agglomeration.

Reference throughout the specification to “one example”, “another example”, “an example”, and so forth, means that a particular element (e.g., feature, structure, and/or characteristic) described in connection with the example is included in at least one example described herein, and may or may not be present in other examples. In addition, it is to be understood that the described elements for any example may be combined in any suitable manner in the various examples unless the context clearly dictates otherwise.

It is to be understood that the ranges provided herein include the stated range and any value or sub-range within the stated range, as if the value(s) or sub-range(s) were explicitly recited. For example, a range from about 0.1 wt % to about 5 wt % should be interpreted to include the explicitly recited limits of about 0.1 wt % to about 5 wt %, as well as individual values, such as 0.2 wt %, 0.25 wt %, etc., and sub-ranges, such as from about 0.15 wt % to about 3 wt %, etc. Furthermore, when “about” is utilized to describe a value, this is meant to encompass minor variations (up to +/−10%) from the stated value.

In describing and claiming the examples disclosed herein, the singular forms “a”, “an”, and “the” include plural referents unless the context clearly dictates otherwise.

While several examples have been described in detail, it is to be understood that the disclosed examples may be modified. Therefore, the foregoing description is to be considered non-limiting.

What is claimed is:

1. A three-dimensional (3D) printing kit, comprising:
a build material composition including polymer particles and an organometallic compound dry-mixed with the polymer particles to prevent Coulombic agglomeration of the build material composition during pneumatic conveyance of the build material composition; and
a fusing agent to be applied to at least a portion of the build material composition during 3D printing, the fusing agent including an energy absorber to absorb electromagnetic radiation to coalesce the polymer particles in the at least the portion.

2. The 3D printing kit as defined in claim 1 wherein the polymer particles are selected from the group consisting of polyamides, polyethylene, polyethylene terephthalate (PET), polyacetals, polypropylene, polyester, polyoxymethylene (POM), polyether ether ketone (PEEK), polyetherketoneketone (PEKK), polyphenylene sulfide (PPS), polytetrafluoroethylene (PTFE), polyvinylidene fluoride (PVDF), and combinations thereof.

3. The 3D printing kit as defined in claim 1 wherein the organometallic compound is selected from the group consisting of a trineoalkoxy amino zirconate, a trineoalkoxy sulfonyl zirconate, and combinations thereof.

4. The 3D printing kit as defined in claim 1 wherein the organometallic compound comprises a polymer with a conjugated pi-orbital backbone.

5. The 3D printing kit as defined in claim 4 wherein the polymer with the conjugated pi-orbital backbone is selected from the group consisting of poly(metalyne), poly(metallophthalocyanines), metal poly(benzodithiolene), poly(metalloethylene terathiolate), poly(metal tetrathio-oxalate), and combinations thereof.

6. The 3D printing kit as defined in claim 1 wherein the organometallic compound is present in an amount from about 0.1 weight percent (wt. %) to about 10 wt. % based on a total weight of the build material composition.

7. A three-dimensional (3D) printing method, comprising:
depositing a build material composition, the build material composition including a mixture of a powdered organometallic compound and a polymer particle powder;
curing at least a portion of the build material composition to form a layer of a three-dimensional object; and
pneumatically conveying an uncured portion of the build material composition to be redeposited in a subsequent deposition.

8. The 3D printing method as defined in claim 7 wherein the polymer particles are selected from the group consisting of polyamides, polyethylene, polyethylene terephthalate (PET), polyacetals, polypropylene, polyester, polyoxymethylene (POM), polyether ether ketone (PEEK), polyetherketoneketone (PEKK), polyphenylene sulfide (PPS), polytetrafluoroethylene (PTFE), polyvinylidene fluoride (PVDF), and combinations thereof.

9. The 3D printing method as defined in claim 7 wherein the organometallic compound is selected from the group consisting of a trineoalkoxy amino zirconate, a trineoalkoxy sulfonyl zirconate, and combinations thereof.

10. The 3D printing method as defined in claim 7 wherein the organometallic compound comprises a polymer with a conjugated pi-orbital backbone.

11. The 3D printing method as defined in in claim 10 wherein the polymer with the conjugated pi-orbital backbone is selected from the group consisting of poly(metalyne), poly(metallophthalocyanines), metal poly(benzodithiolene), poly(metalloethylene terathiolate), poly(metal tetrathio-oxalate), and combinations thereof.

12. The 3D printing method as defined in claim 7 wherein the organometallic compound is present in an amount from about 0.01 weight percent (wt. %) to about 10 wt. % based on the total weight of the build material composition.

13. The 3D printing method as defined in claim 7 wherein the uncured portion is stable at a printing temperature.

14. A method for three-dimensional (3D) printing, comprising:
applying a build material composition to form a build material layer, the build material composition including a mixture of a powdered organometallic compound and powdered polymer particles;
based on a 3D object model, selectively applying a fusing agent on at least a portion of the build material layer;
exposing the build material layer to electromagnetic radiation to coalesce the build material composition in the at least the portion to form a layer of a 3D object;
gleaning recyclable powdered build material from the 3D object; and
pneumatically conveying the recyclable powdered build material and the build material composition, wherein the build material composition includes at least 5 weight percent recyclable powdered build material based on the total weight of the build material composition.

15. The method for three-dimensional (3D) printing as defined in claim 14 wherein:
the powdered polymer particles are selected from the group consisting of polyamides, polyethylene, polyethylene terephthalate (PET), polyacetals, polypropylene, polyester, polyoxymethylene (POM), polyether ether ketone (PEEK), polyetherketoneketone (PEKK), polyphenylene sulfide (PPS), polytetrafluoroethylene (PTFE), polyvinylidene fluoride (PVDF), and combinations thereof; and
the powdered organometallic compound is selected from the group consisting of a trineoalkoxy amino zirconate, a trineoalkoxy sulfonyl zirconate, an organometallic compound including a polymer with a conjugated pi-orbital backbone, and combinations thereof.
